(19) United States
(12) Patent Application Publication
(10) Pub. No.: US 2016/0285791 A1
(43) Pub. Date: Sep. 29, 2016

(54) METHOD AND A SYSTEM FOR ESTABLISHING A COMMUNICATION CHANNEL USING INSTANT MESSGE SERVICES

(71) Applicants: Min-Lee Teng, Taipei (TW); Mack Teng, Taipei (TW); Ming-Chang Huang, Taoyuan County (TW)

(72) Inventors: Min-Lee Teng, Taipei (TW); Mack Teng, Taipei (TW); Ming-Chang Huang, Taoyuan County (TW)

(21) Appl. No.: 14/941,600

(22) Filed: Nov. 15, 2015

Related U.S. Application Data
(60) Provisional application No. 62/139,056, filed on Mar. 27, 2015.

(51) Int. Cl. H04L 12/58; H04W 4/14

(52) U.S. Cl. CPC H04L 51/04; H04L 51/32; H04W 4/14

(57) ABSTRACT

A system for establishing an instant messaging communication channel between a first account ID and a second account ID is disclosed, wherein each of the first account ID and the second account ID is registered with a same instant messaging service, the system comprising: a database for respectively associating a plurality of identifications to a plurality of account ID(s) of the instant messaging service; and a server, configured to: associate a first account ID with a first identification in the database, obtain a same first identification from a message received from a second account ID, so as to establish an instant messaging communication channel between the first account and the second account of the instant messaging service according to the same first identification.

### CROSS-REFERENCES TO RELATED APPLICATIONS

This application claims the benefit of U.S. Provisional Patent Application No. 62/139,056 filed on Mar. 27, 2015, which are hereby incorporated by reference herein and made a part of specification.

### BACKGROUND OF THE INVENTION

1. Field of the Invention

The present invention relates to forwarding messages using instant messaging service and in particular to forwarding messages using instant messaging service for lost and found activities.

2. Description of Prior Art

Conventionally, a website is used to provide a service for lost and found activities, wherein each user must register an account to access the content of the website for obtaining the service. However, the website is a central portal, and the user must login each time when he/she is trying to access the website, and the central portal website has no effective way to establish a user to user communication in real time. As a result, it is not suitable for certain applications, such as lost and found, that require a user to user communication in real time.

Conventional technologies for lost and found activities use email or SMS (Short Message Service) for connecting the finder and the owner of a lost property for returning the property. However, email or SMS do not provide a good view to show all of the messages in a single chat or conversation from the beginning to the end, due to the fact the each email or SMS message is treated independently with a subject title associated with each email or SMS message. In addition, email or SMS cannot support text and voice messages in a single session or conversation between two users.

Furthermore, email or SMS is not readily integrated with all of the useful hardware features of a mobile phone, as a result, email or SMS cannot take advantage of full features of the mobile phone for providing a fast service for lost and found activities. As a result, an efficient way is need to establish a communication channel between two users of mobile phones for certain applications, such as lost and found.

### SUMMARY OF THE INVENTION

One objective of present invention is to provide an effective way to establish an instant messaging communication channel between two different accounts of an instant messaging service without having to expose their own account ID(s) to each other.

One objective of present invention is to provide an effective way to establish an instant messaging communication channel between two different accounts of an instant messaging service for lost and found activities, wherein the instant messaging communication channel is capable of supporting both text and voice messages in a single conversion for facilitating the returning of a lost property.

In one embodiment, a system for establishing a communication channel to exchange messages between remote terminal devices through the Internet is disclosed, the system comprising: a database, wherein a first account ID of a first instant messaging service is associated with a first identification, wherein the first account ID is registered on the first remote terminal device for exchanging messages; one or more servers configured to: receive first information from a second remote terminal device on which a second account ID is registered with the first instant messaging service for exchanging instant messages, wherein a same first identification and the second account ID are obtained according to said first information; and associate the second account ID with the first account ID in the database according to said same first identification, so as to establish a communication channel to exchange messages between the second remote terminal device and the first remote terminal device through the Internet.

In one embodiment, the third account of the first instant messaging service is used for bridging all the messages related to an identification in the database so as to allow two different accounts of the first instant messaging service to chat with each other in an anonymous manner.

In one embodiment, said same first identification is obtained by inputting an image pattern on a media into the second remote terminal device, wherein the third account is pre-determined before said image pattern on the media is inputted into the second remote terminal device for obtaining the same first identification.

In one embodiment, the third account is registered with the first instant messaging service as Official Account or Public Account or Service Account of the instant messaging service, wherein said one or more servers receive the messages related to the first identification via the Official Account or Public Account or Service Account of the instant messaging service. Please note that we will call all such Official Account or Public Account or Service Account of the instant messaging service as Official Account of the instant messaging service since Official Account or Public Account or Service Account is to provide a service to user accounts.

In one embodiment, a method for establishing a communication channel to forward messages between remote terminal devices through the Internet is disclosed, the method comprising: receiving, using one or more servers, first information from a first remote terminal device, wherein a first account ID is registered with a first instant messaging service on the first remote terminal device for exchanging messages with other accounts of the first instant messaging service through the internet, wherein a first identification and the first account ID of the first instant messaging service are obtained from said first information, so as to register the first identification with the first account ID of the first instant messaging service in a database if the first identification is not yet registered in the database; receiving, using said one or more servers, second information from a second remote terminal device, wherein a second account

ID is registered with the first instant messaging service on the second remote terminal device for exchanging messages with other accounts of the first instant messaging service through the internet, wherein a same first identification as registered in the database and the second account ID of the first instant messaging service are obtained from said second information received from the second remote terminal device; and associating, using said one or more servers, the second account ID of the first instant messaging service with the first account ID of the first instant messaging service in the database via said same first identification as registered in the database, so as to establish a communication channel for exchanging messages between the second remote terminal device and the first remote terminal device via the association of the second account ID of the first instant messaging service registered on the second remote terminal and the first account ID of the first instant messaging service registered on the first remote terminal in the database.

In one embodiment, before said first information is received for registering the first account ID and the first identification in the database, the first identification has not been used for entering information related to an object associated with the first identification.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1A illustrates a schematic of an integrated system for establishing an instant messaging communication channel between two accounts by using a Tag ID;

FIG. 1B illustrates a schematic of an integrated system of FIG. 1A for establishing an instant messaging communication channel using a pre-determined account inside the service infrastructure for processing messages related to a Tag ID;

FIG. 2A illustrates a schematic of a system for establishing an instant messaging communication channel using a pre-determined account outside the service infrastructure for processing messages related to a Tag ID;

FIG. 2B illustrates a schematic of the system of FIG. 2A for establishing multiple instant messaging communication channels to a single mobile phone by using a channel ID to identify each of the instant messaging communication channels;

FIG. 2C illustrates a schematic of a system for establishing an instant messaging communication channel with multiple dedicated account ID(s) for processing messages related to Tagged message.

FIG. 3A illustrates a schematic of a system for switching messages between two different instant messaging services;

FIG. 3B illustrates a schematic of a system for using the same Tag ID in two different instant messaging services;

FIG. 4A-4G illustrate a configuration of a mobile phone using the system in FIG. 1, FIG. 2A-2C and FIG. 3; and

FIG. 5 illustrates pre-configured messages for user to select for lost and found application.

### DETAILED DESCRIPTION OF THE INVENTION

The detailed explanation of the present invention is described as following. The described preferred embodiments are presented for purposes of illustrations and description and they are not intended to limit the scope of the present invention.

An instant messaging service offers real-time text, video or voice transmission over the Internet. Instant message is a useful application for providing a user-to-user communication in real time, especially for smart phone users. Each of the instant messaging services, LINE, WeChat, WHATSAPP, Facebook Messenger, Viber, Snapchat, Talk, Ch@t On and etc., can be referred as an instant message service, especially for mobile phone users. Different account ID(s) (or USER NAMES such as Peter, Mike) of an instant messaging service can exchange instant messages between each other via the service infrastructure of the instant messaging service through the Internet. Each message being forwarded by an instant messaging service has a source account field containing a source account that sends out the message and a destination account field containing a destination account that will receive the message, the servers of the infrastructure of the instant messaging service receive the message from the source account and forwards the received message to the destination account. Two different accounts of an instant messaging service needs to be “friends” before they can contact each other in a non-anonymous way, which is very much different from Email or SMS, because two different accounts Email or SMS can contact each other without needing to be “friends” in advance.

In one embodiment of the present invention, there is no need to use other types of accounts for inputting information. For example, for lost and found service, there is no need to create an addition account to enter information related to the lost and found activities. All of the data entries related to the lost and found activities can be entered by using the existing account of the instant message service that is already used by the owner for exchanging instant messages with other people, and the finder and the owner of the property can use his/her own existing account of the instant message service for exchanging instant messages for returning a lost property, which provide a fast and efficient way for returning a lost property to the owner compared with conventional technologies, such as Email service or the SMS service.

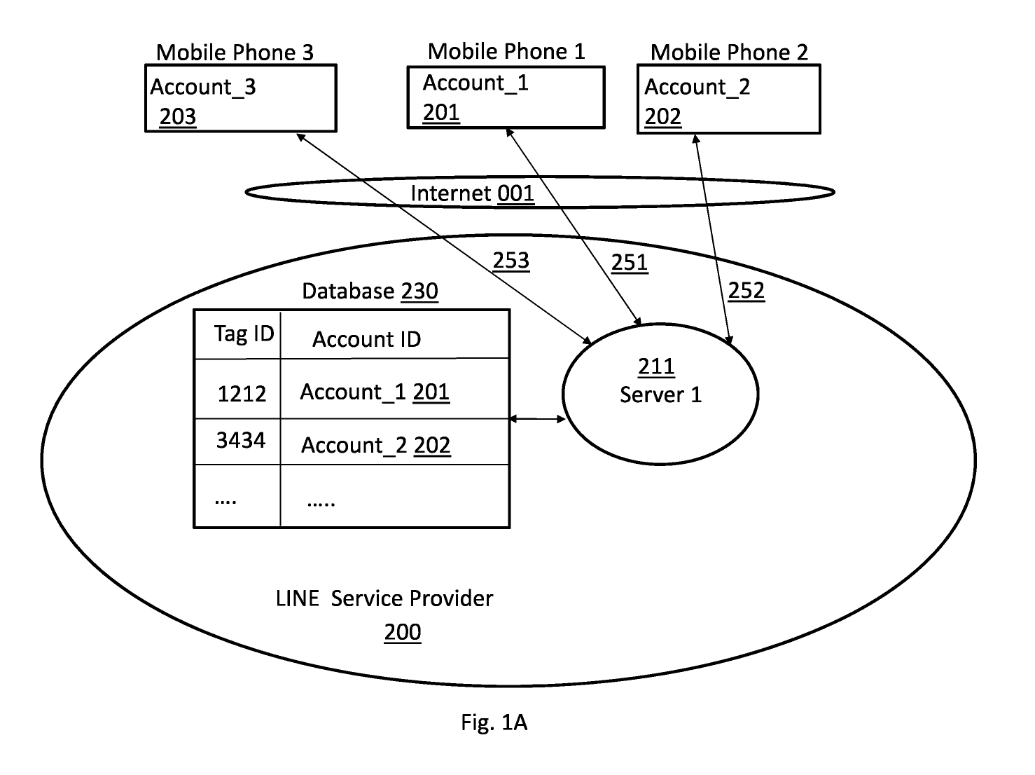

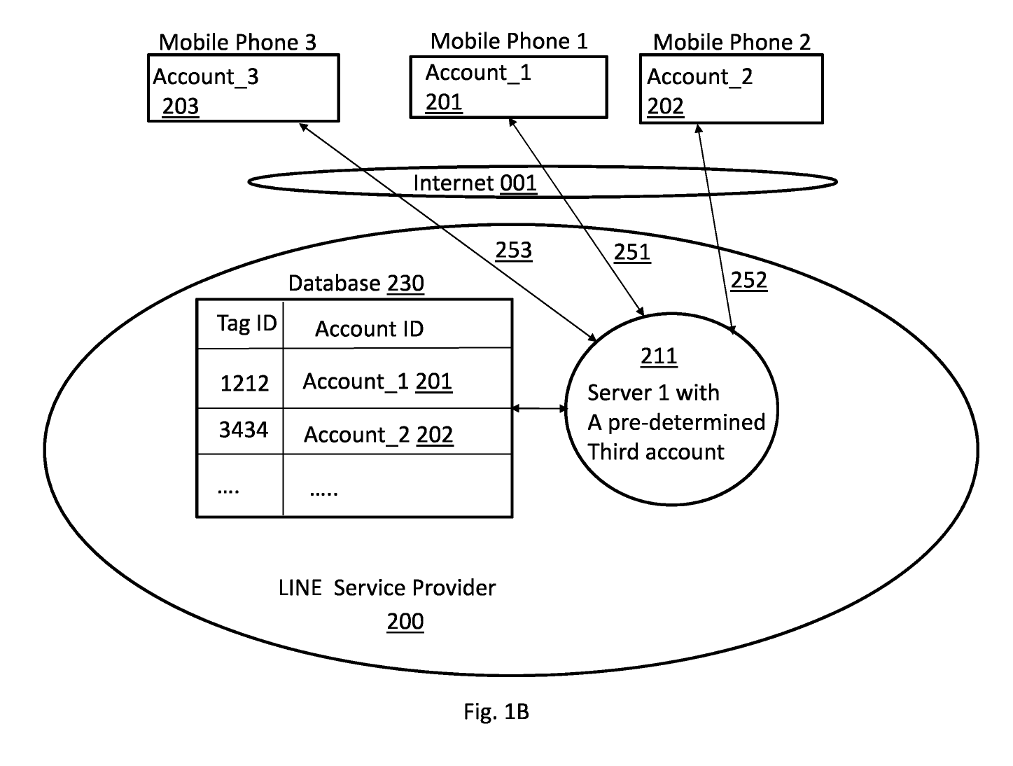

As shown in FIG. 1, in one embodiment, a first user of mobile phone 1 registers a tag through his mobile phone through an instant messaging service, for example, LINE but not limited to, wherein mobile phone 1, having a LINE account: Account_1 201 registered with LINE, can use a camera of the mobile phone to capture the image pattern, such as a QR code on the tag. Once the image pattern is taken, the instant messaging application of LINE miming on the mobile phone 1 can send a message, comprising the LINE account of the first user: Account_1 201 and the captured image pattern of the QR code to a remote server 1 211, after the LINE instant message is received by the server 1 211, it will register the LINE account: Account_1 201 with a tag ID 1212 being converted from the QR code carried in the message, as shown in the database 230. Please note that QR code is only an example for obtaining the identification, such as a tag ID, other image patterns such as a bar code can be used to obtain the identification. After the tag ID 1212 is registered with LINE account: Account_1 201 in the database 230, another user such as a finder of a lost property can contact the owner by using his/her mobile phone to capture the same QR code and sends a message to the server 1 211 for locating the account of the owner in the database 230. Pease note that they are many ways to determine the owner of the tag, for example, the first time the tag ID is received from a first user and the tag ID is not stored in the database 230, then it can be determined that the first user is the owner of the tag. In one embodiment, a password can be used to verify the first user is the owner for sure, that is, the tag will be sold with a password, so only the buyer of the tag knows the password. After the tag ID is registered, a finder can contact the owner by using the same tag ID, wherein the owner and the finder are maintained anonymous to each other, without releasing any contact information to each other at all. For example, the finder can use GPS of his mobile phone to let the owner to pick up the lost property at the location reported by the GPS, or the finder can tell the location, such as a fixed and well known location, of the lost property so that the owner can pick it up.

The purpose of using the QR code is to allow the owner of the tag ID remain anonymous, wherein the QR code can be decoded in the server 1 211 to maintain the highest privacy of the owner of the tag ID. In one embodiment, the QR code can be decoded in the mobile phone 1 instead of the server 1 211. In one embodiment, after the tag ID 1212 is registered and attached to a property, a second user can use his mobile phone 3 to scan the tag when the property is found, wherein the mobile phone 3 is registered with an Account_3 203 with LINE. After the tag is scanned into the mobile phone 3, the instant messaging application of LINE miming on the mobile phone 3 can send a message to the server 1 211 for contacting the first user. After the server 1 211 receives the message, it will convert the image to the tag ID 1212. At this point, the server 1 211 will look up the database 230 to find the Account_1 201 according to the tag ID 1212, and then the server 1 211 can forward the LINE message to Account_1 201 on the mobile phone 1. Likewise, the mobile phone 2 can also scan a tag to register the tag with the server, for example, the tag ID is 3434 and it is mapped to Account_2 202 as shown in the database 230, then the mobile phone 3 can send a message carrying the QR code of the tag to the server, then the server will receive the LINE message and convert the embedded QR code to tag ID 3434, the server 1 111 will look up the database 230 to find the Account_2 202 in the database 230 according to the tag ID 3434, and then the server 1 111 can send the LINE message to the Account_2 202 on the mobile phone 2. By using the same tag ID for both the owner and the finder of a lost property, a communication channel can be established between the mobile phone of the owner and the mobile phone of the finder through the existing LINE instant messaging service, wherein each of the mobile phone of the owner and the mobile phone of the finder has registered a LINE account for exchanging instant messages already, which will simplify the procedures for returning a lost property significantly, wherein all of the data entries related to the lost property or pre-configure messages for returning the lost property can be performed and bound to the existing LINE account, without using any other accounts for data entries related to the lost property.

In this embodiment, the service infrastructure of the instant messaging service has an integrated function to provide such service using identifications, so that it can support user to user communication in an anonymous way. Furthermore, the server 1 211 is capable of forwarding normal messages being not associated with an identification, such as a tag ID, in the database. In each of the normal messages, both the user of the source account and the user of the destination account are not anonymous to each other. Normal messages are delivered from user account to user account without using the identifications or tag ID(s) of the present invention. In order to support both normal messages being not associated with an identification in the database and the messages related to an identification, a pre-determined third account ID can be used to differentiate the normal messages and the messages related to an identification, wherein the pre-determined third account ID is located inside the service infrastructure of the first instant messaging service and is not assigned to any user or business account outside the service infrastructure of the first instant messaging service. That is, the pre-determined third account is like a virtual account of the first instant messaging service so that the servers of the service infrastructure of the first instant messaging service can tell which messages are related to a tag ID or not. However, for such integrated function supported by the service infrastructure of the first instant messaging service, there can be other ways to differentiate the normal messages and the messages related to tag ID(s), for example, the messages related to the tag ID(s) can be sent to a special server inside the service infrastructure of the first instant messaging service for further processing, or a special message type can be used to differentiate the messages related to the tag ID(s) from other types of messages.

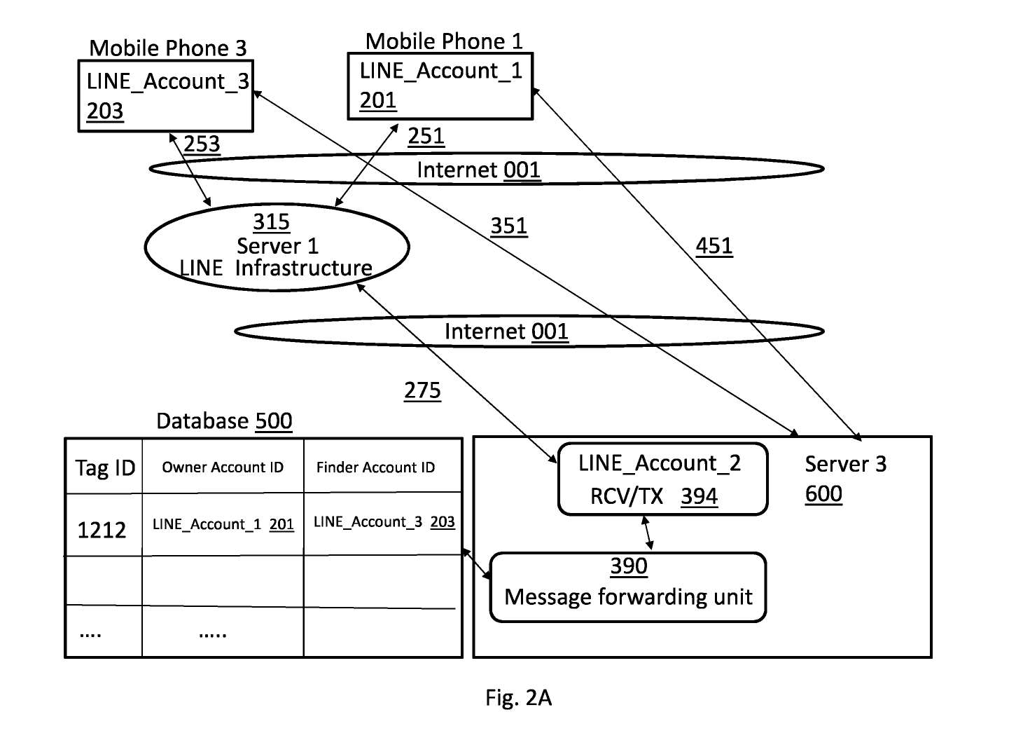

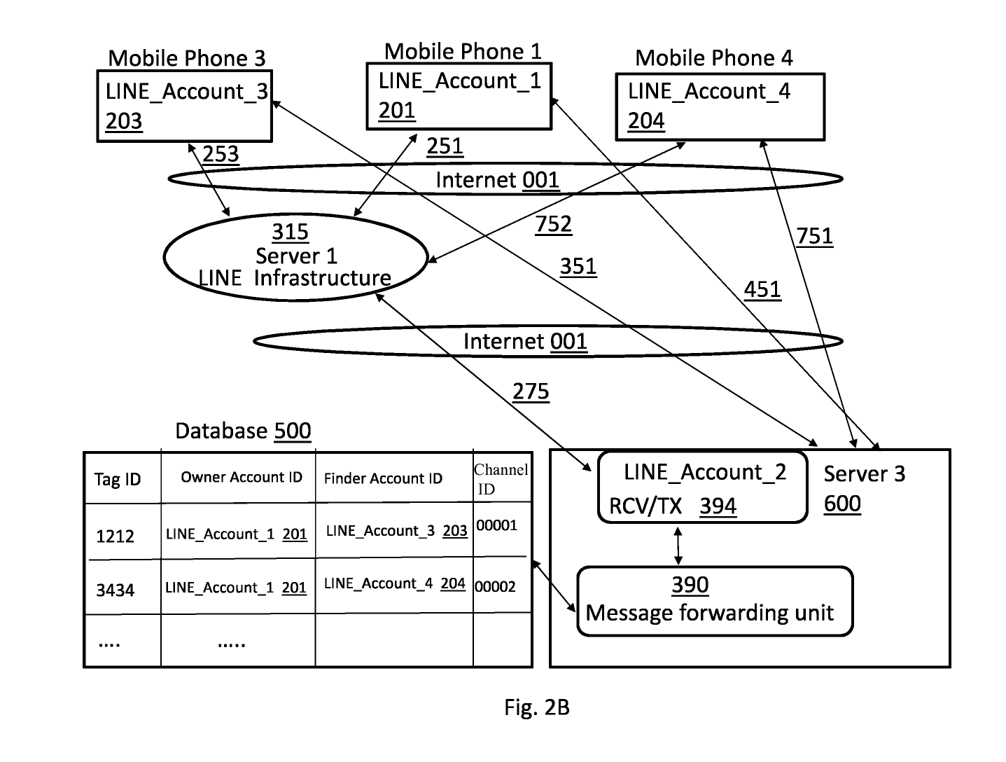

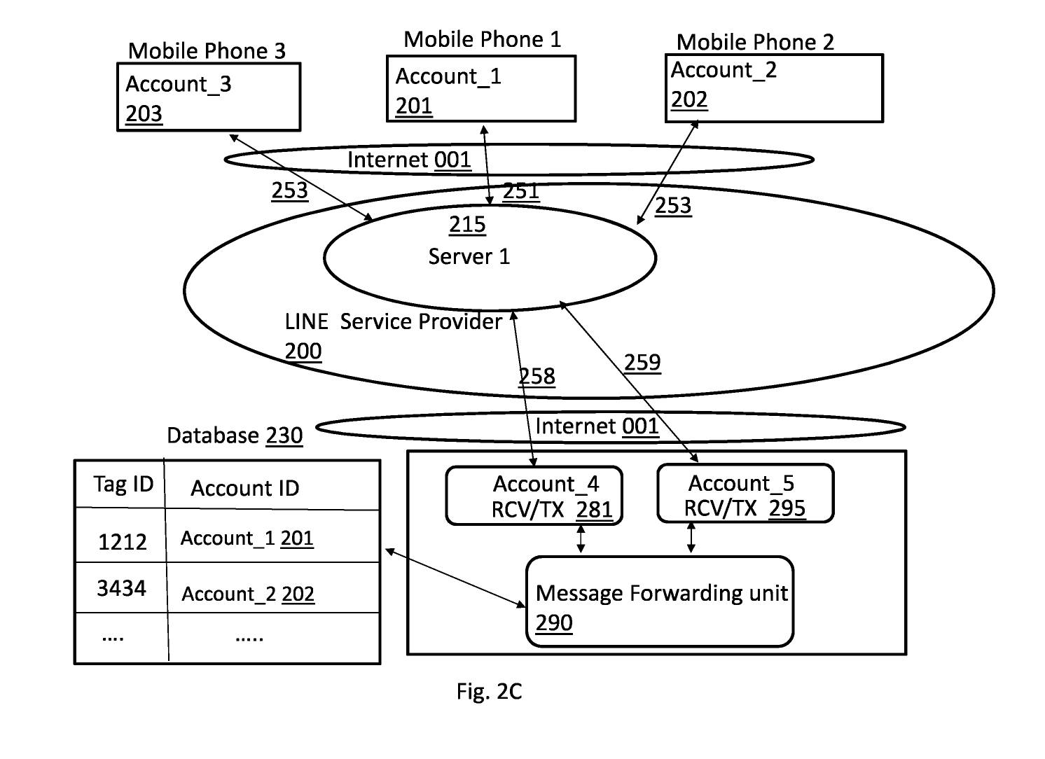

As shown in FIG. 2A, a predetermined third account registered with the instant messaging service is used to forward the messages related to tag ID(s), wherein the predetermined third account of FIG. 2A is located outside the service infrastructure of the first instant messaging service. In one embodiment, a first application program is running on a first remote terminal such as mobile phone 1, wherein LINE_Account_1 201 is registered with the first instant messaging service, such as LINE, on the mobile phone 1 for exchanging messages with other accounts of the LINE service through the internet, wherein an image pattern on a media is captured into the mobile phone 1 for forming at least one first message comprising information for associating the first account ID and the first identification, by using said at least one first application program; at least one second application program running on a second remote terminal such as mobile phone 3, wherein LINE_Account_3 203 is registered with the LINE service on the mobile phone 3 for exchanging messages with other accounts of the LINE service through the internet, wherein an image pattern on a media is captured into the mobile phone 3 for forming at least one second message for associating LINE_Account_3 203 and the first identification, by using said at least one second application program; one or more servers such as server 3 600 coupling to remote terminals such as mobile phone 1, 3 through the Internet 001, wherein said server 3 600 is configured to: receive said at least one first message from the mobile phone 1, wherein a first identification and the owner account ID: LINE_Account_1 201 are obtained according to said at least one first message received from the mobile phone 1 so as to associate the first identification and the owner account ID: LINE_Account_1 201 in the database 500, receive said at least one second message from the mobile phone 3, wherein a same first identification and the second account ID are obtained according to said at least one second message received from the mobile phone 3, associate the finder account ID: LINE_Account_3 203 with the owner account ID: LINE_Account_1 201 in the database 500 according to the same first identification, wherein a communication channel is established for forwarding messages from the mobile phone 3 to the mobile phone 1 via the association of the finder account ID: LINE_Account_3 203 and the owner account ID: LINE_Account_1 201 in the database 500, wherein the owner account ID: LINE_Account_1 201 is obtained from the database 500 according to a third message received from the finder account ID: LINE_Account_3 203 on the mobile phone 3, so as to forward the third message to the mobile phone 1 according to the owner account ID: LINE_Account_1 201 obtained from the database 500.

In one embodiment, the mobile phone 3 can send a message to the mobile phone 1 through the data path 451, 451 by using the server 3 600 to forward the messages, because mobile phone 1 is identified by LINE_Account_1 201 and mobile phone 3 is identified by LINE_Account_3 203, wherein the LINE_Account_1 201 and LINE_Account_3 203 is associated in the database 500 already.

In one embodiment, at least one first application program on mobile phone 1 201 can communicate with the server 3 600 through data path 351 without going through the LINE service infrastructure, that is, without using the LINE instant messaging service.

In one embodiment, the at least one first application program running on mobile phone 1 201 can periodically send polling messages to the server 3 600 to download messages associated with LINE_Account_1 201 to the mobile phone 1 201 through data path 351 without using LINE service infrastructure 315, or instead, the server 3 600 can obtain the IP address of the mobile phone 1 201 so as to send messages associated with LINE_Account_1 201 to the mobile phone 1 201 through data path 351 without using LINE service infrastructure 315. Each of the at least one first and second application program can be an integrated instant messaging application program, such as LINE or WeChat instant messaging application program, or instead, it can be one or more programs working together, for example, an APP that uses the API interface of the instant messaging application program for sending or receiving messages through the instant messaging service. The APP can communicate with the server 3 600 directly without using the instant messaging service to reduce the traffics going through the service infrastructure of the instant messaging service. For example, the user of the mobile phone 1 201 has a tag ID 1212 registered in the database 500, when the user of the mobile phone 3 203 scan an image pattern such as the OR code on the tag, LINE_Account_3 203 of the mobile phone 3 203 can send a message comprising the QR code through LINE instant messaging service to the server 3 600 via LINE_Account_2 394. Then, the server 3 600 will store the message that is destined to LINE_Account_1 201 on the mobile phone 1 201 in a storage, since the QR code is decoded into the tag ID 1212 which is associated with LINE_Account_1 201 in the database 500. In one embodiment, the server 3 600 can send the message received from the mobile phone 3 203 to the server 1 315 through the data path 275 using the LINE service, and then the mobile phone 1 201 can get the message from the mobile phone 3 203 through the data path 251. In another embodiment, the server 3 600 will not send the message received from the mobile phone 3 203 to the server 1 315 for forwarding the message received from the mobile phone 3 203, instead, the server 3 600 can send the message to mobile phone 1 201 through the data path 351 without using the LINE service. The APP running on the mobile phone 1 201 can poll the server 3 600 so as to download the message that was sent from the mobile phone 3 203.

In one embodiment, the APP miming on the mobile phone 1 201 will interface with an API of the LINE instant messaging application to get the information of LINE_Account_1 201 on the mobile phone 1 201 so that the APP running on the mobile phone 1 201 can send a polling message comprising the LINE_Account_1 201 to the server 3 600 for downloading messages for LINE_Account_1 201. After the server 3 600 receives a polling message comprising the LINE_Account_1 201, it will obtain the LINE_Account_1 201 from the polling message and send the message that is received from the mobile phone 3 to the mobile phone 1 201 through the data path 351. By doing so, the finder such as the user of mobile phone 3 can simply use the existing LINE instant application program running on the mobile phone 3 to communicate with the tag owner, while the owner of the tag can install the APP which can talk to the server 3 600 directly without any limitation that might be imposed by the LINE service. The APP running on the mobile phone 1 can interface with the LINE instant application program to access the LINE service so as to send or receive the normal messages through the LINE_Account_1 201 of the mobile phone 1 201. By doing so, the owner of the Tag can exchange instant messages using LINE instant application program as usual, while the APP can provide a dedicated interface for certain targeted application such as lost and found. The APP on the mobile phone 1 can be customized for lost and found activities for the owner of the tag. The APP on the mobile phone 1 can use the camera of the mobile phone 1 to capture the image pattern, such as a QR code, on the tag and send a message to the server 3 600 through data path 351, wherein the message comprises the OR code for decoding into an identification, and the message comprises LINE_Account_1 201 or the information representing the LINE_Account_1 201, so that the server 3 600 can obtain the LINE_Account_1 201 and the tag ID 1212 decoded from the OR code from the message so as to associate the tag ID 1212 and the LINE_Account_1 201 in the database 500. In one embodiment, the finder that uses the LINE_Account_3 203 on mobile phone 3 can use the camera of the mobile phone 3 to capture the image pattern, such as a QR code, on the tag and send a message to the server 3 600 through data path 253, and 275, wherein the message comprises the OR code for decoding into an identification, and LINE_Account_3 203 or the information representing the LINE_Account_3 203, so that the server 3 600 can obtain the LINE_Account_3 203 and the tag ID 1212 decoded from the OR code from the message, so as to associate the LINE_Account_3 203 and LINE_Account_1 201 via the tag ID 1212 in the database 500.

In one embodiment, the mobile phone 3 captures the image pattern, such as a QR code, on the tag, and decodes the QR code to obtain the LINE_Account_2 394 and the tag ID 1212, such that the mobile phone 3 is capable of sending a message to the LINE_Account_2 394, so that the server 3 600 can associate the LINE_Account_3 203 and LINE_Account_201 via the tag ID 1212 in the database 500, wherein the mobile phone 3 captures the image pattern through the instant messaging application of LINE running on the mobile phone 3 for exchanging instant messages through the service infrastructure of the instant messaging service, LINE. That is, the instant messaging application of LINE running on the mobile phone 3 has an integrated function to input the LINE_Account_2 394 and the tag ID from a single QR code to allow the user of the mobile phone 3 to contact the owner of the tag ID with a single QR code, which is convenient for the finder to return a lost object.

In one embodiment, the APP can be used for both owner of the tag as well as the finder of the tag to provide a full service to certain targeted applications such as lost and found. The APP running on the mobile phone 3 of the finder can communicate with the server 3 600 through the data path 451 as well as the 253, 275 using the LINE instant messaging service depending on the needs of the application. The above description can be applied to other instant message service such as WeChat, Whatsapp or Facebook messenger as well. The LINE_Account_2 202 registered with the first instant messaging service on the server 3 600 can receive and send messages to other accounts of the first instant messaging service such as LINE instant messaging service. The application programs running on terminal devices such as mobile phone 1 and mobile phone 3 can send messages to the LINE_Account_2 202 through the LINE service infrastructure and receive messages from the LINE_Account_2 202 through the LINE service infrastructure, which means LINE_Account_2 202 is pre-configured on the server 3 for communicating with the LINE_Account_1 201 of the mobile phone 1 and the LINE_Account_3 203 of the mobile phone 3. In case, the owner has multiple tags and multiple finds are contacting the owner, the sessions of the conversation between the owner and each of the finder will be mixed, since messages delivered through Internet is based on broadband access, unlike the SMS using the telephone network which is a narrow band access, only one user can contact the owner until said one user is done with the SMS transferring, on top of that, each short message will not be combined with another short messages to form a conversation, which is different from the instant messaging in which all of the messages per conversation are continuously displayed on the screen. In one embodiment, the owner of the tag such as the user of the mobile phone 1 can use the data path 251, 275 to communicate with the server 3 600 or the data path 451 to communicate with the server 3 600, or switching between these two paths depends on the needs. Data path 451 can be accessed by the mobile phone without any restrictions imposed by the instant messaging API, in one embodiment, when the server 3 600 sends a message to the mobile phone 1 through the data path 451, and at certain point, the data path needs to switch to data path 251, 275 through the LINE_Account_1 201 of the mobile phone 1, either the APP that uses the data path 451 to communicate with the server 3 600 can switch to the data path 251, 275 by using the API of the instant messaging application or it can display a message on the screen of the mobile phone 1 so that the user of the mobile phone one is alerted to open the LINE instant messaging application running on the mobile phone 1, after the mobile phone 1 is opening the Official Account of the system of the present invention, and then the server 3 600 can download the messages to the mobile phone 1 and continue from there. That is, the Official Account, LINE_Account_2 202 6, is known to the mobile phone 3 so as to allow the mobile phone 3 to communicate with the Official Account: LINE_Account_2 202 before mobile phone 3 captures or inputs the image pattern, such as a QR code on a media, into the mobile phone 3, wherein the QR code can be decoded into the tag ID 1212.

As shown in FIG. 2B, in order to support multiple channels to reach the owner correctly, when the owner has multiple tags and multiple finds are contacting the owner, the messages between the server 3 600 and the LINE_Account_1 201 of the mobile phone 1 will carry a channel ID to uniquely identify the communication channel between the owner and each of the finder that contacts the owner at the same time. For example, when a first finder who is using the mobile phone 1 finds a tag ID 1212 of the owner and contacts the owner, the communication channel ID can be set to 00001 and stored in the database 500 by the server 3 600 and all the messages transmitted from the server 3 600 to the mobile phone 3 will carry the channel ID 00001, after mobile phone 1 receives the message containing the channel ID 00001, mobile phone 1 will extract the channel ID 00001 and embeds the channel ID 00001 in the response message back to the mobile phone 3 of the first finder, so that the server 3 600 can look up the channel ID 00001 in the database 500 to forward the message to the first finder of mobile phone 3; and when a second finder who is using the mobile phone 4 finds a tag ID 3434 of the owner and contacts the owner, the communication channel ID can be set to 00002 and stored in the database 500 by the server 3 600 and all the messages transmitted from the server 3 600 to the mobile phone 4 will carry the channel ID 00002 through data path 752 using the LINE service or data path 751 without using the LINE service. After mobile phone 1 receives the message containing the channel ID 00002, mobile phone 1 will extract the channel ID 00002 and embeds the channel ID 00002 in the response message back to the mobile phone 4 of the second finder, so that the server 3 600 can look up the channel ID 00002 in the database 500 to forward the message to the mobile phone 4 of the second finder. In one embodiment, the channel ID will be the tag ID itself so that there is no need to create another channel ID for uniquely identify each channel. By using the identification such as tag ID, each lost property have its own tag ID and it is easily to identify the lost property according to the tag ID.

In one embodiment, the channel ID to identify the communication channel corresponding to the first identification is selected through information displayed on a screen of the first remote terminal device, wherein the selection is transmitted back to the said one or more servers for forwarding messages from the first account ID to the second account ID while the communication channel corresponding to the first identification is selected, that is, each of the messages from the first account ID does not need to carry information for identifying the communication channel linking to the second account ID while the communication channel corresponding to the first identification is selected and known to said one or more servers of the system of the present invention.

In one embodiment, a control bar of a manual displayed on the screen of the first remote terminal device shows each identification that is associated with the first account ID in the database and has at least one message received form remote terminal devices via said each identification in order to contact the user of the first remote terminal device, wherein one of the identifications on the control bar is selected on the first remote terminal device for responding messages by the user of the first remote terminal device, wherein the selected identification can be represented in many ways such as the identification itself, or a nick name of the identification, or property name associated with the identification, or a channel ID corresponding to the identification, or a channel ID to identify each communication channel that has at least one message received by said one or more servers for transmitting to the first remote terminal device.

In one embodiment, a plurality of identifications associated with the first account ID in the database has at least one received message displayed on the first remote terminal device, wherein one of the message displayed on the first remote terminal device is selected for responding by the user of the first remote terminal device.

That is, when multiple communication channels are respectively established between remote mobile phones and the mobile phone 1 via the third account LINE_Account_2 202, as shown in FIG. 2B, one of said multiple communication channels is determined as an active communication channel for the user of the mobile phone 1 to respond messages, said active communication channel is determined according to a prior agreement between the mobile phone 1 and the server 3 600, such that the server 3 600 is capable of forwarding said responded messages to a corresponding account of the instant message service that is associated with the LINE_Account_1 201 and said active communication channel in the database. By doing so, there is no need to carry the channel ID in the messages sent from the LINE_Account_201 of the mobile phone 1 to the server 3 600 via LINE_Account_2 202, because the server 3 600 knows which communication channel is active for forwarding a responded message from the mobile phone 1, and after the responded message is received by the server 3 600, the server 3 600 will check the database 500 to find out the destination account for forwarding the responded message according to the active communication channel identified by the channel ID in the database 500, for example, if the active communication channel corresponds to channel ID 0001, it will forward the responded message from the mobile phone 1 to LINE_Account_3 203; if the active communication channel corresponds to channel ID 0002, it will forward the responded message from the mobile phone 1 to LINE_Account_4 204, as shown in the database 500.

In one embodiment, messages received at the third account LINE_Account_2 202 from said multiple communication channels are forwarded to the LINE_Account_201 on the mobile phone 1 regardless which communication channel is active, because such messages are all destined to the mobile phone 1, there is no issue in terms of which mobile phone the messages should be sent. That is, based on the prior agreement between the server 3 600 and the mobile phone 1 to set up the active communication channel, there is no need to embedded the channel ID in all of the messages, either from the server 3 600 to the mobile phone 1 or vice versa.

However, by embedding the channel ID in the messages can allow the user of the mobile phone to communicate with all finders at the same time without a prior agreement between the server 3 600 and mobile phone 1. For example, the mobile phone 1 displays a manual comprising information for selecting a first dialogue corresponding to the channel ID 0001 or a second dialogue corresponding to the channel ID 0001, as shown in FIG. 2B, and the user of the mobile phone 1 can select either channel ID to respond messages due to the fact that channel ID(s) are received by the mobile phone 1 already.

In one embodiment, messages received at LINE_Account_2 202 from said active communication channels are forwarded to the LINE_Account_201 on the mobile phone 1, and messages received from another communication channel of said multiple communication channels are queued in a storage device by using the server 3 600, wherein said queued messages are transmitted to the LINE_Account_201 on the mobile phone 1 when said another communication channel becomes active.

In one embodiment, the server 3 600 transmit the status of each communication channel to the LINE_Account_1 201 on the mobile phone 1, wherein each status comprising number of messages received from the corresponding communication channel for transmitting to the LINE_Account_1 201 on the mobile phone 1, wherein the user of the first terminal device selects one of the communication channels as the active communication channel for responding messages by pressing an icon corresponding to the selected communication channel.

In one embodiment, the server 3 600 transmit each message received from the communication channel to the LINE_Account_1 201 on the mobile phone 1, wherein the mobile phone 1 responds a received message displayed on the first remote terminal device when said received message is pressed by the user of the mobile phone 1.

If the finder and owner knows each other or in certain application, two parties connected by the tag ID can make phone call and the server 3 600 will connect the finder and the owner directly without further going through the forwarding process by the server 3 600, at this time, the finder and the owner will communicate through the instant messaging service such as LINE, We Chat, Whapsapp instant messaging service, without going through the forwarding account LINE_Account_2 202 and the two parties will not be in anonymous mode by connected directly through the instant messaging service. Otherwise, server 3 600 can forward the voice call and voice message between the two parties in anonymous mode. Server 3 600 can uses LINE Account 2 202 to communicate with each LINE Account ID of the terminal devices such as mobile phones, and when the server3 600 receive a message for associating the identification with an account ID of the instant message service such as Line or WeChat, the server 3 can send a manual to the corresponding account of the instant message service so as to display the manual on the screen of the mobile phone, wherein the user of the mobile phone can select items on the manual so as to obtain a service. 2.

In one embodiment, a plurality of identifications are associated with the first account ID in the data base, and a plurality of finders are contacting the first account at the same time, wherein each finder is contacting the owner of the plurality of identifications according to one of plurality of identifications, wherein each of the plurality of identifications are different from each other, wherein said one or more servers receives information from each of the finder through a corresponding account on a mobile phone so as to associate the corresponding account ID of the finder to the account ID of the owner via the corresponding identification that is associated with an object found by the finder, and the servers of the system will send a manual, or the manual is already on the screen, for the user of the mobile phone 1 to select a dialogue corresponding to an identification, for example, a first dialogue corresponding to the first identification that is associated with the account ID of the owner and the account ID of the finder 1 in the database or a second dialogue corresponding to a second identification that is associated with the account ID of the owner and the account ID of the finder 2 in the data base, after the selection is confirmed, said one or more servers will forward messages from the account of the owner on the mobile phon1 to a corresponding account of a finder, for example, if the first dialogue is selected, all of the messages will be forwarded to the account ID of the finder 1 or to the account ID of the finder 2 if the second dialogue is selected. The owner can change the selection of the dialogue from time to time as needed, wherein messages corresponding to a newly selected dialogue or identification will be displayed or refreshed so that the user can view them without interleaving with other messages corresponding to other identifications, or remove a dialogue completely as needed, for example, if a lost property corresponding to the first identification is returned, then the owner can remove the dialogue corresponding to the first identification. In one embodiment, in order to forward a message from the finder to the owner, the owner must open the dialogue first or send a message to the pre-determined account associate with said servers so that the servers of the system is able to download all of the messages from the finder to the account of the owner. The pre-determined account associate with said servers can be an Official Account or a public account or a business account that is registered with the corresponding instant messaging service, such that the owner and a finder can communicate with the Official Account or a public account or a business account to create a dialogue between the owner and the finder so as to return a lost property or complete some other activities.

In one embodiment, the pre-determined account and an identification can be encoded in a single QR code such that once the QR code is captured into the mobile phone of the owner by using the instant messaging application program running on the mobile phone of the owner, the instant messaging application program will send the identification from the account of the owner to the pre-determined account through the instant messaging service automatically to make contact with the servers of the system; likewise, a finder can capture the same QR code to its mobile phone so that it will send the identification found by the finder to the pre-determined account automatically to make contact with the servers of the system, for contacting the owner.

In one embodiment, the owner or the finder must contact the pre-determined account first, then the pre-determined account will send a manual for capturing the QR code comprising an identification back to the pre-determined account so that the owner or the finder can contact each other through the identification. In one embodiment, there is a software program running on the mobile phone of the owner such that once the servers of the system receives a message form a finder, the servers will send a message to the mobile phone of the owner by using said software program which will prompt a message on the screen to notify the owner there is a message from the finder that can be viewed the owner, wherein the message can be viewed by using said software or the owner of the identification needs to open the instant messaging application program so as to making contact with the pre-determined account for viewing the message form the finder.

The LINE_Account_2 202 can be an Official Account of LINE or Public Account of WeChat (we will call it a pre-determined account or pre-determined account of an instant messaging service of a corresponding instant messaging service since it bridges the messages between terminal devices such as from the mobile phone 1 to mobile phone3 or vice versa, and also and provide service information to mobile phones), wherein each of the mobile phone can make a friend with the pre-determined account to obtain a service so that the owner of the tag can select the pre-determined account on mobile phone for registration a tag and the finder of the tag can select the pre-determined account on mobile phone for contacting the owner.

The tag ID can be associated information related to the owner, once the tag is registered and all of the information can be entered and associated with the tag ID, the owner of the tag ID can give this tag to other people, such that they can use the tag to download an electronic business card of the owner of the tag, the server 3 600 will manage or coordinate with other servers to manage all the business cards of the owners of the tags. Please note that, in addition to provide information associated with the tag, the tag can be used for a person having the tag to send messages or make a call to the owner of the tag as needed. The system or the server 3600 sends a message comprising an operation interface for displaying on the mobile phone 3 in response to the message received from the mobile phone 3 that contains the tag identification such that the user of the mobile phone 1 can operate on the interface for communication with said one or more servers through the pre-determined third account registered on said one or more servers for contacting the owner.

The operation interface can include a manual of items for the user of the mobile phone 1 to select, it can be just like a GUI (graphic user interface) displayed on a touched screen for user to select or press so as to select items for sending back to said one or more servers through the pre-determined third account registered on said one or more servers. All of information related to a property or luggage can be inputted through the operation interface, likewise, the finder of the tag can select the type of the item that he finds or the finder can select to make a call to the owner if both parties agree to do so. 19. The system of claim 1, wherein said information is inputted into the second remote terminal device by transmitting wireless signals from said media into the second remote terminal device, wherein said wireless signals is decoded into the same first identification by using said one or more servers.

In one embodiment, an identification can be obtained from a RFID or a near field communication (NFC) device, wherein each of the RFID and NFC device can transmit wireless signals to a mobile phones so that the identification can be decoded from said wiles signals for associating with an account ID of an instant messaging service registered on the mobile phone.

In one embodiment, an identification obtained from a tag or a media is associated with a corresponding sequence number in the database for binding a user of a remote terminal device. For example, a restaurant owns a tag ID 6688 which is associated with a LINE account ID in the database 500. The user of the mobile phone 3, having a LINE_Account_3 203 registered on the mobile phone 3, is a customer of the restaurant who is holding the tag ID 6688 while ordering a meal from the restaurant, the tag has an image pattern thereon for decoding into the identification, tag ID 1212. In addition, a readable sequence number for sequencing the customers of the restaurant, such as 1, 2, 3, ...etc., can be printed or attached on the tag or media for people to read, such that once the user of the mobile phone 3 captures the image pattern into the mobile phone 3, the mobile phone 3 will send a message to the server 3 600 to associate LINE_Account_3 203 with the tag ID 6688, wherein the tag ID 6688 is already associated with said readable sequence number in the database 500. By doing so, the user of the mobile phone 3 can be associated with said readable sequence number in the database automatically. At this time, the user of the mobile phone 3 can communicate with the server 3 600 to order a meal, wherein the server 3 600 can send a manual to the mobile phone 3 for the user to select, after the selection is confirmed by the user, the server 3 600 will send a message to the LINE account ID of the restaurant to prepare for the meal order associated with said readable sequence number. When the meal associated with said readable sequence number is ready for picking up, the service people in the restaurant can transmit a message from the LINE account ID of the restaurant to the server 3 600, the message from the LINE account ID comprising said readable sequence number so that the server 3 600 can transmit a message to the mobile phone 3 to pick up the meal. In one embodiment, the manual for ordering meal can be pre-configured in a storage associated with said server 3 600, wherein said pre-configured can be uploaded from the restaurant, which can be updated when the manual is updated. In one embodiment, wherein said multiple communication channels are capable of being established via the same first identification, and channel ID(s) or sequence numbers are dynamically generated and assigned to identify said communication channels, wherein a sequence number corresponding to a communication channel is transmitted back to the corresponding remote terminal device, such as a mobile phone, from which said communication channel is established. In one embodiment, the sequence number can be used for binding a customer of a business entity and is transmitted back to a corresponding mobile phone for displaying thereon so as to bind the sequence number to the user of the mobile phone. In one embodiment, the sequence number is displayed with a logo of the business entity or the sequence number can be in the center of an image pattern that identifies the business entity, the sequence number can be in a larger size or color so that the user and the business entity can easily recognize it.

Please note that the tag can be used for other services in addition to the lost and found activity. For example, a tag can be registered and attached to a parcel or any item that are delivered to a receiver, the receiver can scan the tag to send a message to the owner of the tag, wherein the sender, for example the owner of the tag, and the receiver can use the same or different instant messaging service through the server(s) which maintain a mapping to map each tag to an account of an instant messaging service for forwarding messages associated with the ID of the tag.

In one embodiment, all of the instant messages related to the Tag ID(s) are handled by the same servers that are already used for forwarding typical or existing instant messages, wherein there is a tag in an instant message to indicate that the instant message contains an image of the tag for special handling. In one embodiment, all of the instant messages having an image of the tag will be forwarded to a special sever or servers for handling, so that typical/normal instant messages and the instant messages having an image of the tag are processed by different servers to avoid confusion. The special server or servers can have a different networking address from that of the servers handling normal instant messages, or the special servers are acting as terminal device of the instant messaging application and having their own account ID of the instant messaging application just like a typical mobile phone user, in this case, all of the special messages having an image of the tag will be forwarded to the special server without changing the existing server(s) that are serving the current normal/typical instant messages.

The software program can be integrated with the LINE or WeChat, or running as a separate application which uses API of the LINE or WeChat to send instant messages. Whenever a user wants to scan the image of the tag, the software program can be invoked to capture the image of the tag, and the software program knows the destined LINE or WeChat account of the server, the server will act as a proxy to deliver the messages between the owner of the tag and the finder, all the follow on messages will embed the ID of the tag to associate all the related messages of the tag, wherein the server will use the API of the instant messaging application, such as LINE or WeChat, to send or receive messages. In the mobile phone, all the follow on messages will be treated as normal instant messages processed by the instant messaging application, such as LINE or WeChat, running in the mobile phone.

In one application, the software program can be installed in any mobile phone or electronic device and will interface with the instant messaging application in the mobile phone. For example, when the software application, will be called APP from now on, is invoked, the APP will activate the camera to take the picture of the image on the tag, after the image is taken, the APP will ask the instant messaging application to send an instant message comprising the information of the image to a server with the predefined destined account of the same instant messaging application that the mobile phone is using. After the server receives the message, it will convert the image to the ID of the tag so as to either register the tag when the tag is not registered yet or find the account of the owner who has registered the tag previously.

As shown in FIG. 2C, there can be multiple pre-determined account ID(s) for receiving those messages comprising identifications or tag ID(s). For example, Account_2 202 can be used to receive messages from Account_3 203, wherein the Account_3 203 sends a first message comprising information for obtaining an identification, such as a tag ID, so that an instant messaging communication channel between Account_3 203 on the mobile phone 3 and the Account_1 201 on the mobile phone 1 can be established. Likewise, Account_5 295 can be used to receiving messages for establishing an instant messaging communication channel between remote terminal devices. In one embodiment, Account_2 202 is used to receiving messages from Account_3 203, and Account_5 295 is used for transmitting messages to Account_3 203. In one embodiment, the transmitted messages may not contain the identification after the instant messaging channel bas been established already.

In one embodiment, A system for switching instant messages between multiple instant messaging applications is disclosed, the system comprising: a first registered account of a first instant messaging application for receiving and transmit instant messages of the first instant messaging application; a second registered account of a second instant messaging application that is different from the first instant messaging application, for receiving and transmit instant messages of the second instant messaging application; and a message forwarding unit, for forwarding instant messages between the first instant messaging application and the second instant messaging application via the first registered account of the first instant messaging application and the second registered account of the second instant messaging application.

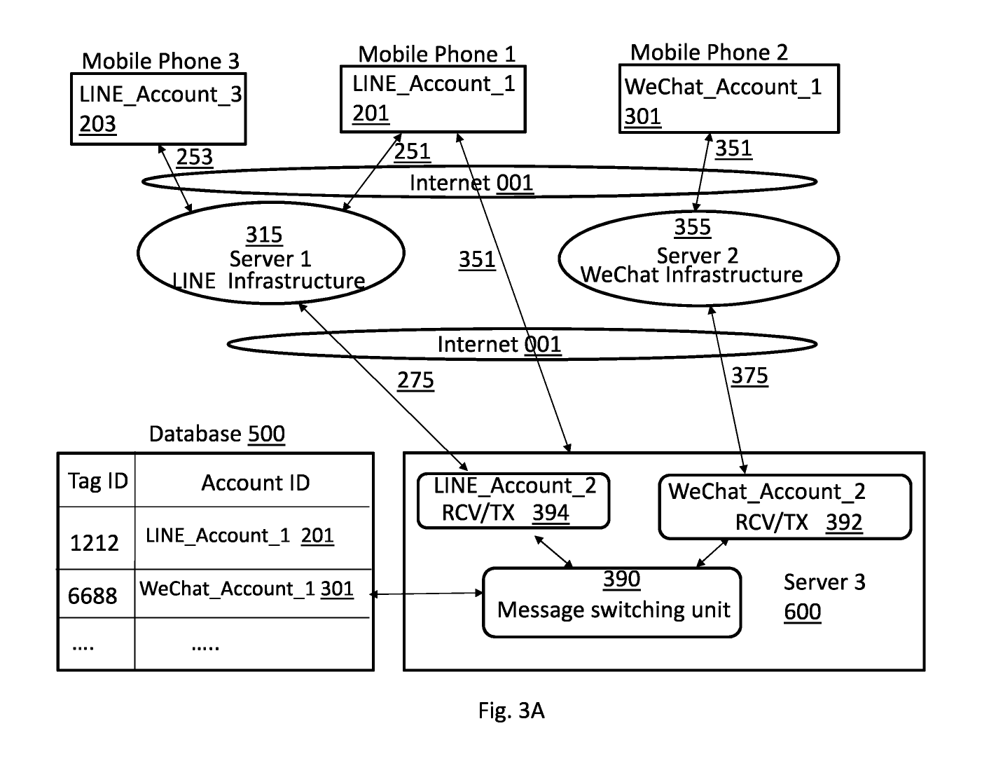

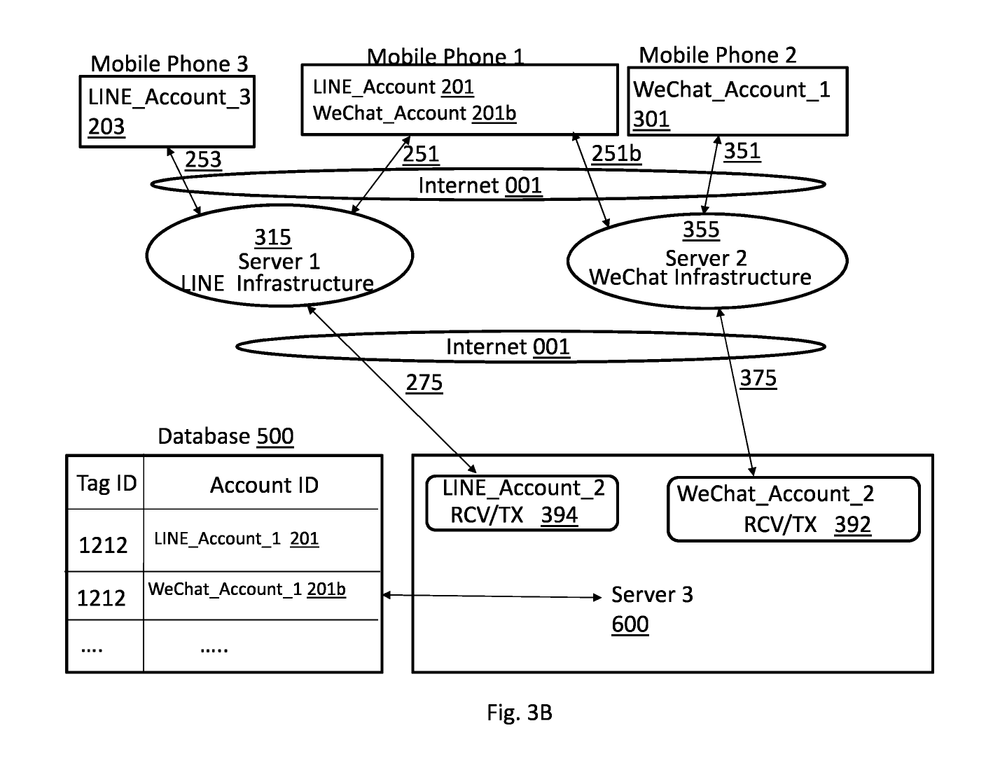

As shown in FIG. 3A, a first user of mobile phone 1 registers a tag through his mobile phone using one instant messaging application, for example, LINE, wherein mobile phone 1 has a LINE account, Account_1 201, the LINE can link with a camera attached to the mobile phone for capturing the image or bar code, QR code on the tag, once the image is taken, the LINE can send a message comprising the LINE account of the first user, Account_1 201, and the captured image to a server in the server farm, wherein a server 3 600 has its own LINE account, Account_2 392 for receiving the LINE instant message, after the LINE instant message is received by the server, it will register the LINE account of the first user, Account_1 201, and the tag ID converted from the captured image embedded in the LINE instant message, and the tag ID is 1212 as shown in the database 230.

After the tag ID is registered and attached to a property, a second user can use his mobile phone 2 to scan the tag when the property is lost, however, the second user uses another instant messaging service, for example, WeChat with a WeChat_Account_1 at this time, the instant messaging service, WeChat, will send a message to the server 3 600 via the Internet 101 for contacting the first user, wherein the server 3 600 has its own WeChat account, WeChat_Account_2 392, for receiving the WeChat instant message from the second mobile phone. After the server receives the WeChat instant message, it will convert the image in the WeChat instant messaging service to the tag ID of the first user, which is 1212. At this point, the server 3 600 will look up the database 500 to find the LINE_Account_1 201 according to the tag ID 1212, and then the message switching unit can convert the format from the WeChat message into LINE message, and the LINE message will be forward to LINE_Account_1 201 on the mobile phone 1.

Likewise, if mobile phone 3 find the tag, it will also send LINE message to the server 3 600 via the Internet 101 for locating the account of the owner of the tag, in this case, the finder and the owner are both using LINE, so there is no need to do the format of the instant messages. Likewise, if the mobile phone 2 is using WeChat, it can also scan a tag to register the tag with the server 3 600, for example, the tag is 3434 and it is mapped to WeChat_Account_301 as shown in the database 500, then the LINE_Account_3 203 on the mobile phone 3 can send a message comprising an image of the tag to the server 3 600 via the Internet 101, then the server 3 600 will receive the LINE message and convert the embedded image to 3434, and then the message switching unit can do the format conversion and send the converted message to WeChat_Account_1 301 on the mobile phone 2.

In order to support multiple users to access a tagged account ID such as WeChat_Account_1 301 at the same time, each instant messaging communication channel can be assigned a channel ID for identifying the instant messaging communication channel, so that WeChat_Account_1 301 can handle multiple instant messaging communication channels at the same time, even when the source account ID or the destination account ID of the instant messaging communication channel remains anonymously to each other.

As shown in FIG. 3B, instead of switching messages between LINE and WeChat instant messaging service, the first user of mobile phone 1 has registered the same tag ID 1212 in both LINE and WeChat instant messaging service, as shown in the database 230 so that the user of mobile phone 3 can contact the first user of mobile phone through LINE instant messaging service using the tag ID 1212, and the user of mobile phone 2 can contact the first user of mobile phone through WeChat instant messaging service using the same tag ID 1212.

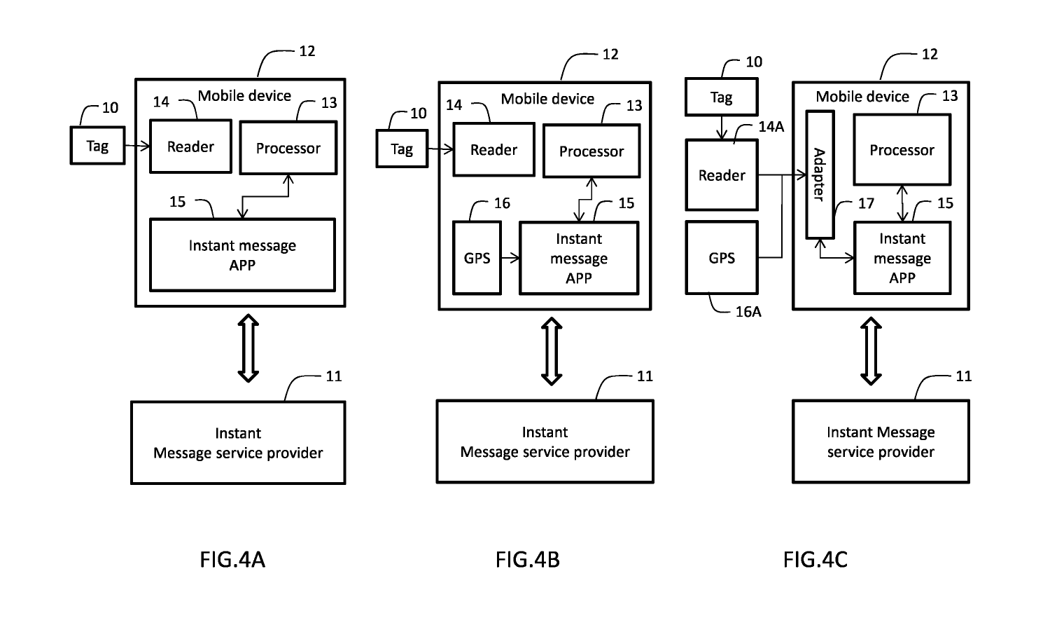

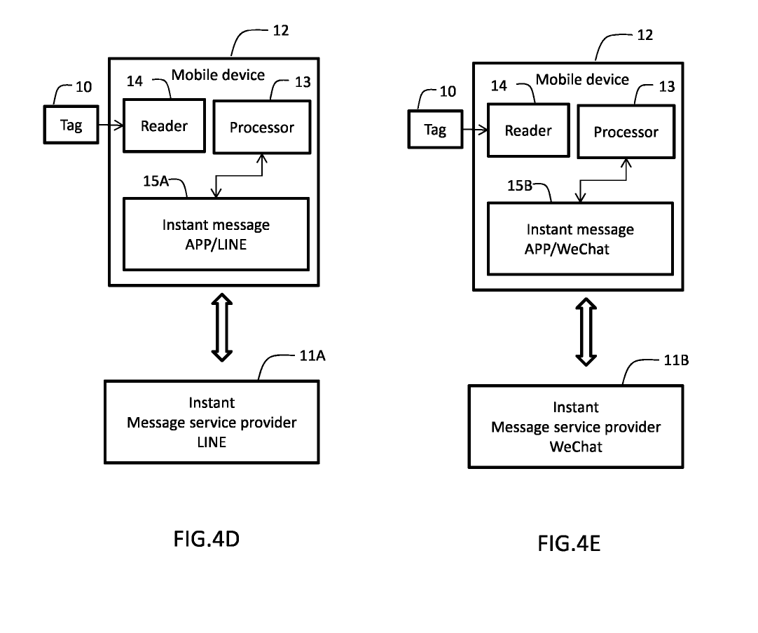

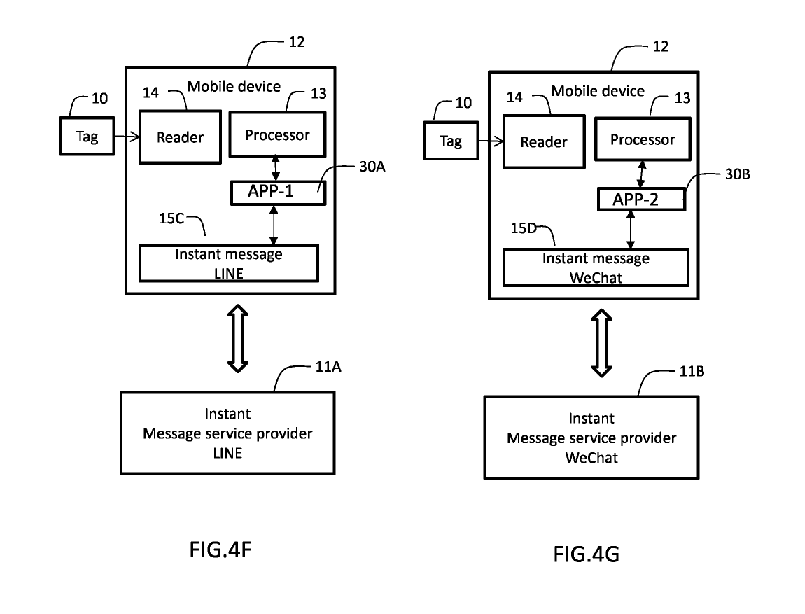

FIG. 4A-4C is a block diagram showing that the mobile device 12 comprises a processor 13 and a reader 14 for operating with an instant messaging service 15. The reader 14 is capable of inputting an image pattern on a tag 10 for obtaining a tag ID, and send the message with the inputted image pattern embedded therein to an instant message service provider 11. A GPS 16 can be used to provide the location information of the mobile device and the location information can be integrated to the messages as well. An adapter 17 is embedded on the mobile device capable of connecting to an external reader 14A and GPS 16A.

For example, when a lost property is found by a finder, the finder can scan the tag on the lost property, and an instant message including the captured tag along with the GPS location information of the mobile phone can be sent to the owner of the property through an instant message.

FIG. 4D shows that the APP can be integrated with LINE instant messaging service 15A running on the mobile device 12 such as a mobile phone, wherein the LINE instant messaging service 15A on the mobile device 12 can send instant messages via the service provider of the LINE instant messaging service 11A.

FIG. 4E shows that the APP can be integrated with WeChat 15B instant messaging service miming on the mobile device 12 such as a mobile phone, wherein the WeChat instant messaging service 15B send instant messages via the service provider of the WeChat instant messaging service 11B.

FIG. 4F shows that the APP APP-1 30A can be coupled with the LINE instant messaging service 15C through an API of the LINE instant messaging service 15C, running on the mobile device 12 such as a mobile phone, wherein the APP-1 30A can send instant messages to the service provider of the LINE instant messaging service 11A through the API of the LINE instant messaging service 15C. FIG. 4F shows that the APP APP-1 30A can be coupled with the LINE instant messaging service 15C through an API of the LINE instant messaging service 15C, running on the mobile device 12 such as a mobile phone, wherein the APP-1 30A can send instant messages to the service provider of the LINE instant messaging service 11A through the API of the LINE instant messaging service 15C.

FIG. 4G shows that the APP APP-2 30B can be coupled with the WeChat instant messaging service 15D through an API of the WeChat instant messaging service 15C, running on the mobile device 12 such as a mobile phone, wherein the APP-2 30B can send instant messages to the service provider of the WeChat instant messaging service 11B through the API of the WeChat instant messaging service 15C. In one embodiment, the APP is invoked only when the user is about to take the picture to scan the image on the tag, in other times, all follow on messages will be communicated between the owner and the finder by using the server as the intermediary for delivering the messages between the owner and the finder.

However, if the owner and the finder use the same instant messaging service, a direct channel can be established between the owner and the finder, and the server will not be involved in all of the follow on message delivery after the direct channel is established. In one embodiment, all the message forwarding for each instant messaging service will be handled by a dedicated server. For example, there is a server handing all the messages using LINE, and another server will handle all the messages using WeChat, and these two servers will forward the content of the instant message to each other so as to forward messages from the owner to the finder or from the finder to the owner, wherein the owner can use LINE and the finder can use WeChat. Once a tag ID is registered by a user using a first account of a first instant messaging service, the tag can be scan by any other user using any instant messaging service, and all the messages can be forwarded by the server(s) that has registered an account for each instant messaging application, and the APP as mentioned above can be used for capturing image on the tag and send the image of the tag to the server to either register the tag or try to find the owner of the tag when the tag has been registered already.

In one embodiment, the APP is capable of running with multiple different instant messaging applications such that the APP miming in an electronic device such as a mobile phone can determine which instant messaging application the mobile phone is using and link with the instant messaging application for sending a message with the captured image of a tag to the sever for contacting the owner of the tag. In one embodiment, the APP is embedded in multiple different instant messaging applications such that each instant messaging application can send a message with the captured image of a tag for contacting the owner of the tag or for registering the tag by the owner. By doing so, all the instant messaging application can talk to each other through the ID of the tag. Please note that, in one embodiment, the tag is pre-printed for all the users to purchase in a store, then the owner of the tag can register the tag with the server, after that, any person can contact the owner regardless which instant messaging application said any other person is using on his/her mobile phone. For example, the owner is using LINE, and said any other person is using WeChat or other instant messaging application, which are supported by the server.

In one embodiment, the tag can be in electronic form, for example, stored in a mobile phone or a computer or an electronic device, the tag will be sold through data transmission from Internet, in this case, the mobile phone can send the image of the tag to the server for registering, because the image of the tag is stored in the mobile phone already. After the tag ID is registered, the owner can send the image of the tag to other mobile phone so that said other mobile phone can contact the owner of the tag through instant messaging application, wherein the mobile phone of the owner and said other mobile phone can use a same instant messaging application.

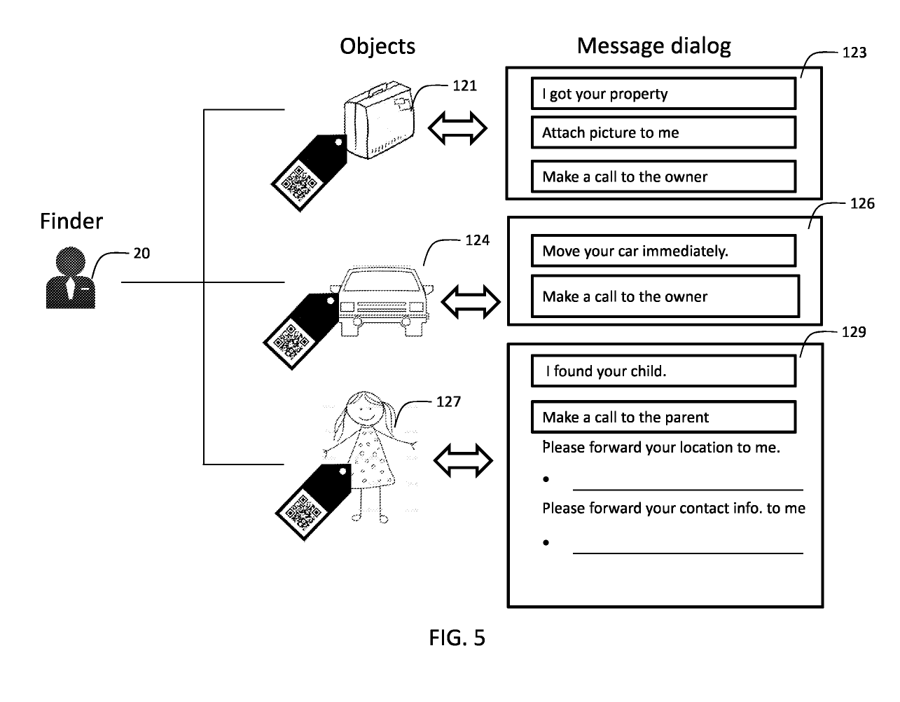

FIG. 5 shows a user interface for the finder 20. A message 123 is sent to the owner of the lost property 121. A message 126 is sent to the owner of the vehicle 124. A message 129 is sent to the parent of the missing child 127. In one embodiment, a voice call icon can be displayed for making a call instead of using text messages. These messages can be pre-designed for certain applications so that a user only needs to click on those messages he/she prefers. These are just few examples that can take advantages of present invention, the present invention can be applied to many other applications as well.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A system for establishing a communication channel to exchange messages between remote terminal devices through the Internet, the system comprising:
a database, wherein a first account ID of a first instant messaging service is associated with a first identification, wherein the first account ID is registered with the first instant messaging service on the first remote terminal device;
one or more servers coupled to remote terminal devices through the Internet, wherein said one or more servers is configured to: receive first information from a second remote terminal device on which a second account is registered with the first instant messaging service, wherein a same first identification and the second account ID are obtained according to said first information; and associate the second account ID with the first account ID in the database according to the said same first identification, so as to establish a first communication channel capable of exchange messages between the second remote terminal device and the first remote terminal device through the Internet, wherein said one or more servers are associated with a third account of the first instant messaging service to receive messages from remote terminal devices, wherein a first message sourced from the second account of the first instant messaging service is received at the third account via the first instant messaging service through the Internet, and the first account is obtained from the database according to the second account obtained from the first message, so as to transmit a second message to the first remote terminal device on which the first account is registered with the first instant messaging service.

2. The system of claim 1, wherein the second message is transmitted from the third account to the first account on the first remote terminal using the first instant messaging service.

3. The system of claim 1, wherein said one or more servers is capable of forwarding normal messages not associated with an identification in the database.

4. The system of claim 1, wherein the second message is transmitted to the first account on the first remote terminal without using the first instant messaging service.

5. The system of claim 1, wherein the said same first identification is obtained by inputting an image pattern into the second remote terminal device, wherein the third account is known to the second terminal device so as to allow the second terminal device to communicate with said one or more servers via the third account of the first instant messaging service, before said image pattern comprising the same first identification is inputted into the second remote terminal device.

6. The system of claim 1, wherein the first communication channel is further capable of forwarding messages from the first account to the second account via the third account of the first instant messaging service.

7. The system of claim 1, wherein said first information is transmitted from the second remote terminal device to said one or more servers by posting a message from the second remote device to said one or more servers without using the first instant messaging service.

8. The system of claim 1, wherein said one or more servers is further configured to:
receive second information from the first remote terminal device, wherein the first identification and the first account ID are obtained according to said second information so as to associate the first account ID and the first identification in the database.

9. The system of claim 8, wherein said second information is transmitted from the first remote terminal device to said one or more servers by posting a message from the first remote device to said one or more servers without using the first instant messaging service.

10. The system of claim 1, wherein said third account is registered with the first instant messaging service as an Official Account for providing a service to user accounts.

11. The system of claim 1, wherein when multiple communication channels are respectively established between remote terminal devices and the first terminal device via the third account, one of said multiple communication channels is determined as an active communication channel for the first remote terminal device to respond messages, said active communication channel is determined according to a prior agreement between the first remote terminal device and said one or more servers, such that said one or more servers is capable of forwarding said responded messages to a corresponding account of the instant message service that is associated with the first account and said active communication channel in the database.

12. The system of claim 11, wherein messages received at the third account from said active communication channels are forwarded to the first remote terminal device and messages received from another communication channel of said multiple communication channels are queued in a storage device by using said one or more servers, wherein said queued messages are transmitted to the first remote terminal when said another communication channel becomes active.

13. The system of claim 1, wherein the first communication channel is capable of delivering voice messages for conducting a phone conversation between the first remote terminal device and the second remote terminal device.

14. The system of claim 1, wherein multiple communication channels are capable of being established to the first remote terminal device at the same time, wherein a channel ID for identifying each communication channel is associated with the first account ID of the first messaging service in the database.

15. The system of claim 14, wherein said multiple communication channels are capable of being established via the same first identification, and channel ID(s) are dynamically generated and assigned to identify said communication channels respectively, wherein the channel ID(s) are numbers arranged in a sequential order, wherein the number corresponding to a communication channel is transmitted back to the corresponding remote terminal device for displaying on a screen thereof.

16. The system of claim 1, wherein the first identification is capable of being associated with a fourth account ID in the database, wherein the fourth account ID is registered with a second instant messaging service on a third remote terminal device, such that the user of the third remote terminal device is capable of contacting the user of the first remote terminal device using the said first identification.

17. A method for establishing a communication channel to forward messages between remote terminal devices through the Internet, the method comprising:
receiving, using one or more servers, first information from a first remote terminal device, wherein a first account ID is registered with a first instant messaging service on the first remote terminal device for exchanging messages with other accounts of the first instant messaging service through the internet, wherein a first identification and the first account ID of the first instant messaging service are obtained from said first information, so as to register the first identification with the first account ID of the first instant messaging service in a database if the first identification is not yet registered in the database;
receiving, using said one or more servers, second information from a second remote terminal device, wherein a second account ID is registered with the first instant messaging service on the second remote terminal device for exchanging messages with other accounts of the first instant messaging service through the internet, wherein a same first identification as registered in the database and the second account ID of the first instant messaging service are obtained from said second information received from the second remote terminal device; and
associating, using said one or more servers, the second account ID of the first instant messaging service with the first account ID of the first instant messaging service in the database via said same first identification as registered in the database, so as to establish a first communication channel capable of exchange messages between the second remote terminal device and the first remote terminal device through the Internet, wherein said one or more servers are associated with a third account of the first instant messaging service to receive messages from remote terminal devices, wherein a first message sourced from the second account of the first instant messaging service is received at the third account via the first instant messaging service through the Internet, and the first account is obtained from the database according to the second account obtained from the first message, so as to transmit a second message to the first remote terminal device on which the first account is registered.

18. The method of claim 17, wherein said one or more servers is capable of forwarding normal messages not associated with an identification in the database.

19. The method of claim 17, wherein the first communication channel is further capable of forwarding messages from the first account to the second account via the third account of the first instant messaging service.

20. The method of claim 17, wherein the said same first identification is obtained by inputting an image pattern into the second remote terminal device, wherein the third account is known to the second terminal device so as to allow the second terminal device to communicate with said one or more servers via the third account, before said image pattern comprising the same first identification is inputted into the second remote
